(19) United States
(12) Patent Application Publication
(10) Pub. No.: US 2018/0164629 A1
(43) Pub. Date: Jun. 14, 2018

(54) DISPLAY DEVICE

(71) Applicant: InnoLux Corporation, Miao-Li County (TW)

(72) Inventors: Hung-Yi Lin, Miao-Li County (TW); Chia-Chun Yang, Miao-Li County (TW); Chin-Cheng Kuo, Miao-Li County (TW)

(21) Appl. No.: 15/832,007

(22) Filed: Dec. 5, 2017

(30) Foreign Application Priority Data
Dec. 14, 2016 (CN) 201611151867.2

(51) Int. Cl. G02F 1/1333; G02F 1/1335

(52) U.S. Cl. CPC G02F 1/133308; G02F 2001/133317; G02F 1/133305; G02F 1/133602

(57) ABSTRACT

A display device includes a display panel, a circuit connecting board, a plurality of passive components and a first insulation layer. The circuit connecting board is connected to the display panel and has a component configuration area. The passive components are disposed on the component configuration area and include a first passive component. The first insulation layer is disposed on the component configuration area and covers the first passive component. The adhesive can be applied on the component configuration area by an automatic dispensing machine, and the adhesive is solidified to form the first insulation layer for covering the passive components. This configuration can prevent the short circuit between the metal material and the components disposed on the component configuration area of the circuit connecting board, thereby benefitting in automatically manufacturing and decreasing the production cost.

### CROSS REFERENCE TO RELATED APPLICATIONS

This Non-provisional application claims priority under 35 U.S.C. § 119(a) on Patent Application No(s). 201611151867.2 filed in People's Republic of China on Dec. 14, 2016, the entire contents of which are hereby incorporated by reference.

### BACKGROUND

### Technical Field

The present disclosure relates to a display device and, in particular, to a display device benefitting in automatically manufacturing.

### Related Art

With the development of technologies, display devices have been widely applied to various fields. Due to the advantages such as low power consumption, less weight, compact size and less radiation, the liquid crystal display (LCD) devices have gradually replaced the traditional cathode ray tube display (CRT) display devices and been applied to various electronic products, such as mobile phones, portable multimedia devices, notebook computers, liquid crystal TVs and liquid crystal screens.

For example, in the manufacturing and assembling of the LCD modules, it is an important subject to reduce the manufacturing cost. In general, the adhesive tape is manually attached to the position corresponding to the module for providing the insulation or buffering function. However, the manually attaching method for disposing the adhesive tape is disadvantageous to the development of the automatically manufacturing and the reducing of assembling cost.

### SUMMARY

An objective of the disclosure is to provide a display device that is benefitting in automatically manufacturing and decreasing the manufacturing cost.

The present disclosure provides a display device including a display panel, a circuit connecting board, a plurality of passive components and a first insulation layer. The circuit connecting board is connected to the display panel and has a component configuration area. The passive components are disposed on the component configuration area and include a first passive component. The first insulation layer is disposed on the component configuration area and covers the first passive component.

As mentioned above, in the display device of this disclosure, the circuit connecting board is connected to the display pane, and the passive components are disposed on the component configuration area of the circuit connecting board. The first insulation layer is disposed on the component configuration area and covers the first passive component. Accordingly, the adhesive can be applied on the component configuration area of the circuit connecting board by an automatic dispensing machine, and the adhesive is solidified to form the first insulation layer for covering the passive component. This configuration can prevent the short circuit between the metal material and the components disposed on the component configuration area of the circuit connecting board, thereby benefitting in automatically manufacturing and decreasing the production cost.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a top view of a display device according to an embodiment of the disclosure;

FIG. 1B is a sectional view of the display device of FIG. 1A along a line A-A;

FIG. 2A is a top view of a display device according to another embodiment of the disclosure;

FIG. 2B is a sectional view of the display device of FIG. 2A along a line B-B;

FIG. 3 is a top view of a display device according to another embodiment of the disclosure;

FIGS. 4A to 4F are schematic diagrams showing the relative relationships of the supporting frame, the spacer and the buffer member;

FIG. 5A is a top view of a display device according to another embodiment of the disclosure; and

FIG. 5B is a sectional view of the display device of FIG. 5A along a line C-C.

### DETAILED DESCRIPTION OF THE DISCLOSURE

The embodiments of the disclosure will be apparent from the following detailed description, which proceeds with reference to the accompanying drawings, wherein the same references relate to the same elements.

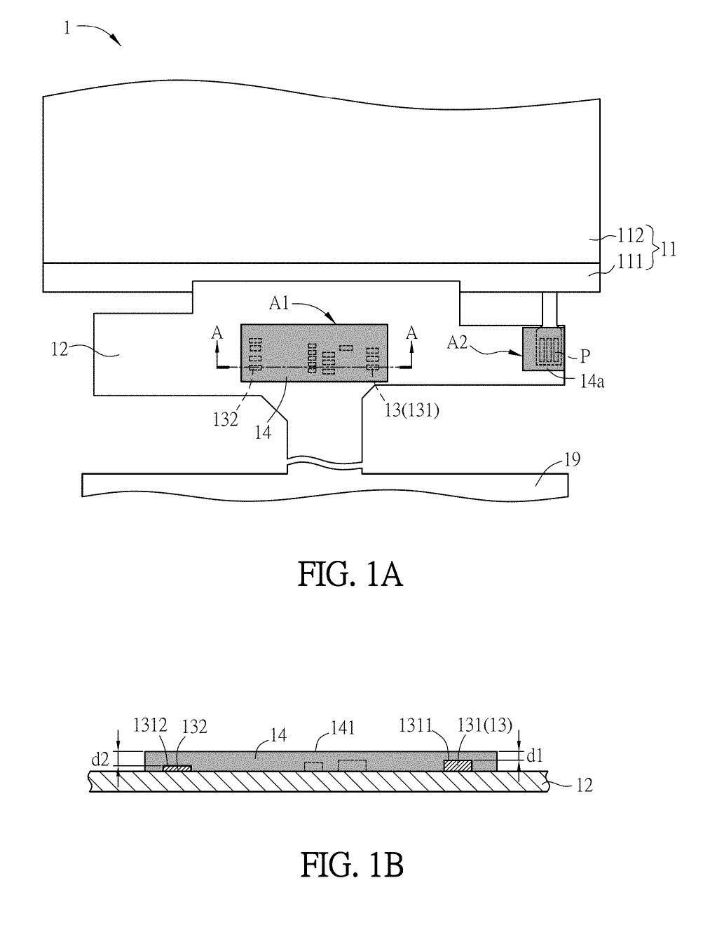

FIG. 1A is a top view of a display device 1 according to an embodiment of the disclosure, and FIG. 1B is a sectional view of the display device 1 of FIG. 1A along a line A-A.

Referring to FIGS. 1A and 1B, the display device 1 can be a liquid crystal display (LCD) device, a light-emitting diode (LED) display device, a quantum dot (QD) display device, a flexible display device or a free shape display device, and this disclosure is not limited. In this embodiment, the display device 1 is an LCD device for example.

As shown in FIG. 1A, the display device 1 includes a display panel 11, a circuit connecting board 12, a plurality of passive components 13 and a first insulation layer 14.

In this embodiment, the display panel 11 can be an FFS (Fringe Field Switching) LCD panel, an IPS (In-plane switch) LCD panel, a TN (Twisted Nematic) LCD panel, a VA mode (Vertical Alignment mode) LCD panel, or any one of other types of LCD panels, and this disclosure is not limited.

The display panel 11 includes a first substrate 111, a second substrate 112, a liquid crystal layer (not shown), and two polarizers 113 (not shown). The first substrate 111 is disposed opposite to and overlapped with the second substrate 112, and the liquid crystal layer is disposed between the first substrate 111 and the second substrate 112. In this embodiment, the first substrate 111 is a TFT (thin-film-transistor) substrate, and the second substrate 112 is a CF (color filter) substrate. In other embodiments, the black matrix or the filter layer of the CF substrate can be formed on the TFT substrate, and the first substrate 111 becomes a BOA (BM on array) substrate or a COA (color filter on array) substrate. This disclosure is not limited. In addition, one of the polarizers can be disposed at one side of the first substrate 111 away from the second substrate 112 (e.g. the lower surface of the first substrate 111), and the other one of the polarizers can be disposed at one side of the second substrate 112 away from the first substrate 111 (e.g. the upper surface of the second substrate 112).

The circuit connecting board 12 is connected to the display panel 11. In practice, the circuit connecting board 12 can be directly, indirectly or electrically connected to the display panel 11. In this embodiment, the circuit connecting board 12 is directly connected to the display panel 11. The circuit connecting board 12 has a component configuration area A1. For example, the circuit connecting board 12 can be a flexible printed circuit board (FPC) or a printed circuit board (PCB). In this embodiment, the circuit connecting board 12 is a flexible printed circuit board, which is connected to, for example but not limited to, a surface of the first substrate 111 facing the second substrate 112.

The passive components 13, which include a first passive component 131 and a second passive component 132, are disposed on the component configuration area A1 of the circuit connecting board 12. In this embodiment, the passive components 13 can be resistors, capacitors, or diodes, which are electrically connected to the display panel 11. In this embodiment, the display device 1 further includes a system circuit board 19, which is electrically connected to the display panel 11 through the circuit connecting board 12. Herein, the system circuit board 19 can include a driving IC or a circuit, such as a scan driver or a data driver, and other circuits, for controlling the display panel 11 to display image through the circuit connecting board.

The first insulation layer 14 is disposed on the component configuration area A1 and covers the first passive component 131. In this embodiment, the first insulation layer 14 can be comprised, for example but not limited to, a light curing adhesive (e.g. UV glue). For example, the light curing adhesive is applied on all passive components 13 of the entire component configuration area A1 by an automatic dispensing machine, and then solidified to form the first insulation layer 14. The adhesive can be applied on the entire component configuration area A1 or on a part of the component configuration area A1 to cover the passive components 13 by the automatic dispensing machine, and this disclosure is not limited.

As shown in FIG. 1B, the first insulation layer 14 has a first surface 141 away from the circuit connecting board 12, and one of the passive components 13 (e.g. the first passive component 131) has a top surface (first top surface) 1311 closest to the first surface 141 of the first insulation layer 14. Herein, the first surface 141 is the upper surface of the first insulation layer 14. A shortest distance (the first distance d1) between the first top surface 1311 of the first passive component 131 and the first surface 141 of the first insulation layer 14 is greater than or equal to 30 μm and is less than or equal to 50 μm (30 μm≤d1≤50 μm). In more detailed, the first insulation layer 14 is disposed to cover the component configuration area A1 of the circuit connecting board 12. The distance between the highest point of the passive components 13 (e.g. the first top surface 1311 of the first passive component 131) and the first surface 141 of the first insulation layer 14 is at least 30 μm for providing a sufficient breakdown voltage (insulation). However, in order to decrease the material cost, the distance between the first top surface 1311 of the first passive component 131 and the first surface 141 of the first insulation layer 14 is less than or equal to 50 μm. Accordingly, the first insulation layer 14 has a sufficient insulation property, and the material cost thereof can be controlled.

In addition, the first passive component 131 has a first top surface 1311 closest to the first surface 141 of the first insulation layer 14. A first distance d1 is between the first top surface 1311 and the first surface 141, and the first distance d1 is the shortest distance between the first passive component 131 and the first surface 141. The second passive component 132 has a second top surface 1321 closest to the first surface 141 of the first insulation layer 14. A second distance d2 is between the second top surface 1321 and the first surface 141, and the second distance d2 is the shortest distance between the second passive component 132 and the first surface 141. Herein, the first distance d1 is different from the second distance d2. In other words, the height of the first passive component 131 is different from the height of the second passive component 132. Of course, in other embodiments, the shortest distances between any two of the passive components 13 and the first surface 141 and the first insulation layer 14 can be the same. In other words, the passive components 13 may have the same height or different heights.

As shown in FIG. 1A, the display device 1 of this embodiment further includes a second insulation layer 14a, and the material of the second insulation layer 14a can be the same as that of the first insulation layer 14. In addition, the circuit connecting board 12 may further include a bonding area A2, which is configured with at least one bonding pad P. In this embodiment, the bonding area A2 is configured with three square bonding pads P, but it is not limited to. The second insulation layer 14a is disposed in the bonding area A2 and covers the bonding pads P. The bonding pads P can be connected to, for example but not limited to, the components (e.g. light-emitting units) of the backlight module or the display panel 11. Similar to the above mentioned first insulation layer 14, the second insulation layer 14a can also be comprised a light curing adhesive. The light curing adhesive is applied on the bonding pads P of the bonding area A2 by an automatic dispensing machine, and then solidified to form the second insulation layer 14a. In some embodiments, the material of the first insulation layer 14 can be different from the material of the second insulation layer 14a.

Due to the automatic manufacturing technology, the manual tape attaching process can be replaced by automatic adhesive dispensing process, and the dispensed adhesive can be solidified to form the first insulation layer 14 and the second insulation layer 14a. In this case, the material of the adhesive has the following characteristics: (1) high insulation; (2) tight attachment; and (3) reworkable. In more detailed, the insulation properties of the first insulation layer 14 and the second insulation layer 14a are superior than the conventional adhesive tape, and the breakdown voltages of the first insulation layer 14 and the second insulation layer 14a must reach a certain value (e.g. 5.5 kV or more) for reducing the short circuit between the components disposed in the component configuration area A1 or the bonding pads A2 of the circuit connecting and other metal materials. Since the applied adhesive has fluidity, the narrow small space on the component configuration area A1 can be completely applied with the adhesive. Thus, the first insulation layer 14 and the second insulation layer 14a can provide a good protection superior than the adhesive tape. In addition, the first insulation layer 14 and the second insulation layer 14a must be tightly attached and are not easily loosened. For example but not limited to, the first insulation layer 14 and the second insulation layer 14a should pass a reliability test (under 85° C. and 85% humidity for 500 hours) and have no breaks. Besides, the first insulation layer 14 and the second insulation layer 14a should also pass an adhesion test for more than 72 hours. Moreover, the functions of the first insulation layer 14 and the second insulation layer 14a are not affected by the warped circuit connecting board 12. In addition, the first insulation layer 14 and the second insulation layer 14a can be removed by solvent, and no or less (compared with adhesive tape) adhesive material of the first insulation layer 14 and the second insulation layer 14a are remained on the circuit connecting board 12.

In the display device 1 of this embodiment, the adhesive can be applied on the component configuration area A1 and the bonding area A2 of the circuit connecting board 12 by the automatic dispensing machine, and then solidified to form the first insulation layer 14 and the second insulation layer 14a, which cover the passive components 13 and the bonding pads P. This configuration can reduce the short circuit between the metal material and the components disposed on the component configuration area of the circuit connecting board, thereby benefitting in automatically manufacturing and decreasing the production cost.

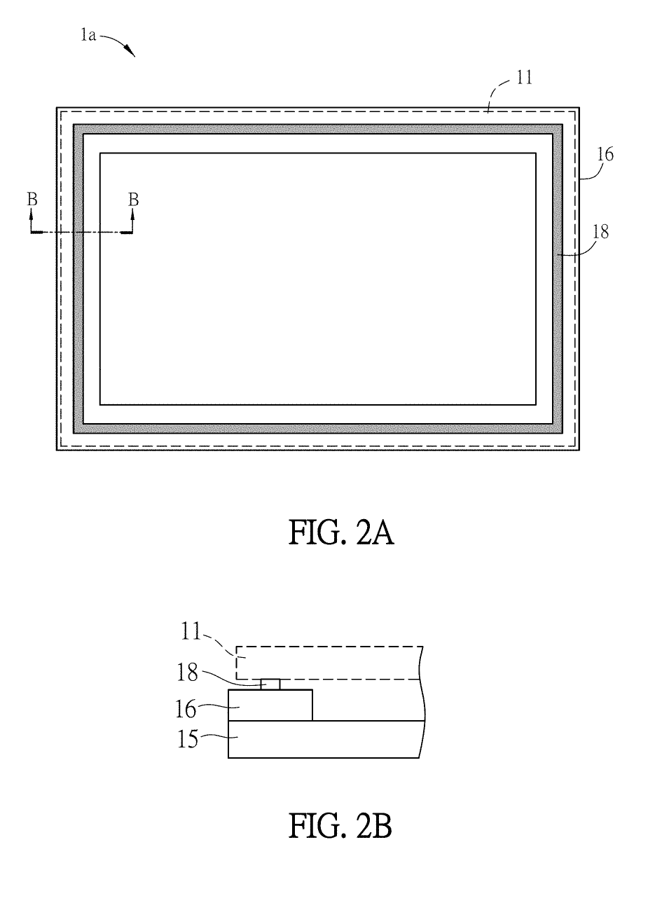

FIG. 2A is a top view of a display device 1a according to another embodiment of the disclosure, and FIG. 2B is a sectional view of the display device 1a of FIG. 2A along a line B-B.

As shown in FIGS. 2A and 2B, the display device 1a includes all technical features of the display device 1 and further includes a backlight module 15, a supporting frame 16 and a buffer member 18.

The backlight module 15 is disposed corresponding to the display panel 11 and emits light toward the display panel 11. The light passes through the display panel 11 so as to display images. In this embodiment, the backlight module 15 can be an edge-type backlight module or a direct-type backlight module, and this disclosure is not limited. FIG. 2A only shows the display panel 11, the supporting frame 16 and the buffer member 18 of the display device 1a and their relative relationships, and FIG. 2B only shows the display panel 11, the backlight module 15, the supporting frame 16 and the buffer member 18 of the display device 1a and their relative relationships. The circuit connecting board 12, the passive components 13, the first insulation layer 14 and the second insulation layer 14a are not shown in FIGS. 2A and 2B.

The supporting frame 16 is disposed on the backlight module 15 and located between the backlight module 15 and the display panel 11. The supporting frame 16 is configured to support the display panel 11. Herein, the supporting frame 16 can be, for example but not limited to, a sealant. In the top view, the shape of the supporting frame is a square disposed surrounding a periphery of the display panel 11. The buffer member 18 is disposed between the supporting frame 16 and the display panel 11 for providing the buffering and supporting functions to the display panel 11. In some embodiments, the supporting frame 18 can be assembled by multiple members or a single-piece structure. The material and manufacturing process of the buffer member 18 can be the same as or different from the first insulation layer 14 (or the second insulation layer 14a). The material of the buffer member 18 can be, for example but not limited to, a light curing adhesive (e.g. UV glue), and it can be applied on the supporting frame 16 and solidified to form the buffer member 18. In this embodiment, the buffer member 18 is disposed on the supporting frame 16, and this disclosure is not limited. In other embodiments, the buffer member 18 can be formed by adhesive dispensing to form discontinuous segments on the supporting frame 16, and this disclosure is not limited.

Due to the automatic manufacturing technology, the manual tape attaching process can be replaced by automatic adhesive dispensing process, and the dispensed material for forming the buffer member 18 should have the above-mentioned characteristics of tight attachment and reworkable. Moreover, compared with the conventional adhesive tape used as the buffer member, the adhesive material (liquid) has better buffering efficiency and static friction coefficient. Accordingly, the buffer member 18 of this disclosure can provide better supporting and buffering functions, so that the display panel 11 can be fixed to reduce the broken issue.

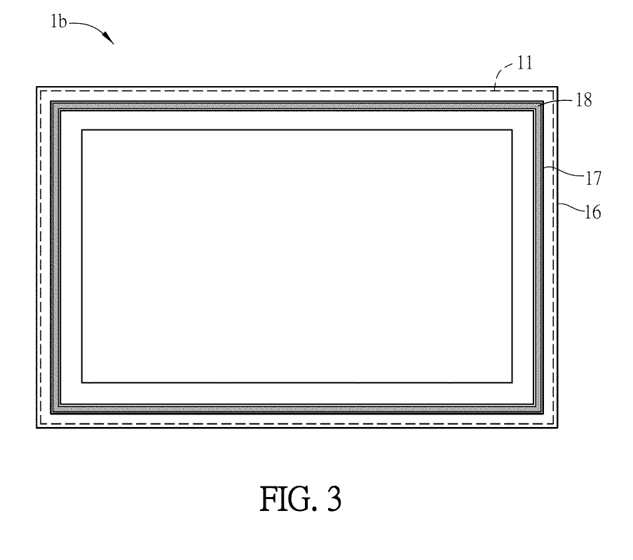

FIG. 3 is a top view of a display device 1b according to another embodiment of the disclosure.

As shown in FIG. 3, the display device 1b includes the display panel 11, the circuit connecting board 12, the passive components 13, the first insulation layer 14, the second insulation layer 14a, the backlight module 15, the supporting frame 16, the buffer member 18, and a spacer 17. To be noted, FIG. 3 only shows the display panel 11, the supporting frame 16, the spacer 17 and the buffer member 18, and the circuit connecting board 12, the passive components 13, the first insulation layer 14, the second insulation layer 14a and the backlight module 15 are not shown.

The spacer 17 is disposed on the supporting frame 16, and the buffer member 18 is disposed between the spacer 17 and the display panel 11. The material of the spacer 17 is, for example but not limited to, polycarbonate (PC), and the buffer member 18 can still provide the supporting and buffering functions to the display panel 11. The configuration of the spacer 17 can reduce the material of the buffer member 18 and enhance the structural strength of the buffer member 18. Besides, the applied adhesive material for forming the buffer member 18 can be more stable.

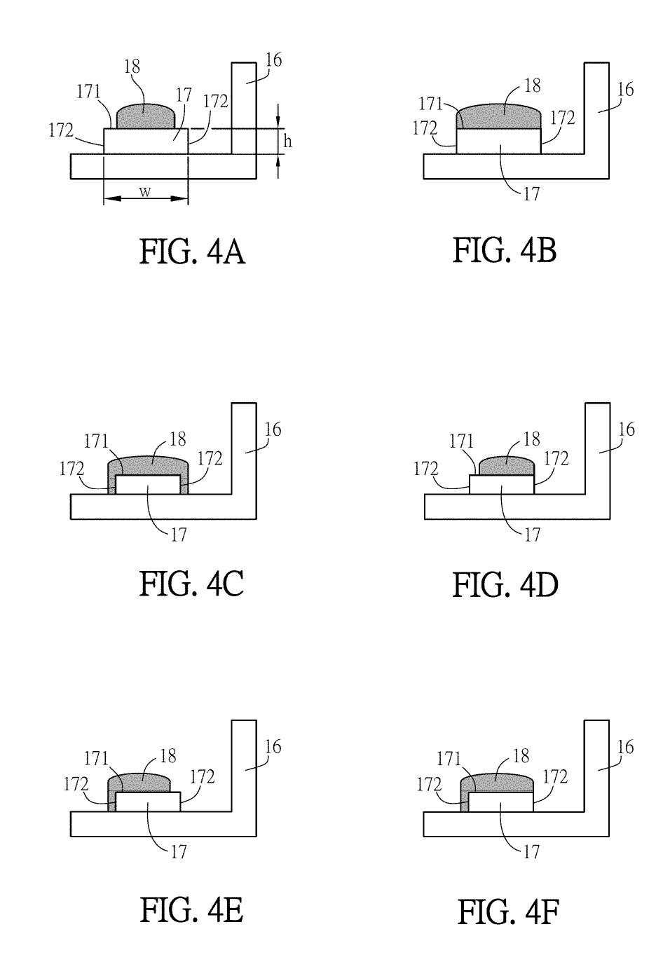

FIGS. 4A to 4F are schematic diagrams showing the relative relationships of the supporting frame 16, the spacer 17 and the buffer member 18.

As shown in FIG. 4A, the spacer 17 is disposed on the supporting frame 16 and has a top surface (fifth top surface) 171 away from the supporting frame 16 and two opposite side surfaces 172. In this aspect, the supporting frame has a reverse L shape, and the two side surfaces 172 of the spacer 17 are connected to the two side surfaces of the supporting frame 16, respectively. In this embodiment, the buffer member 18 covers a part of the fifth top surface 171 of the spacer 17, but the buffer member 18 does not cover the two side surfaces 172 of the spacer 17. In order to obtain a better applying stability of the automatic dispensing machine, the aspect ratio (height:wide) of the spacer 17 can be 1:X. Wherein, X is greater than or equal to 2 and is less than or equal to 4 (2≤X≤4). In one embodiment, X is 4.

As shown in FIG. 4B, the buffer member 18 covers the entire fifth top surface 171 of the spacer 17, but the buffer member 18 does not cover the two side surfaces 172 of the spacer 17. In other words, the buffer member 18 completely covers the fifth top surface 171 and is substantially aligned to the edges of the two opposite side surfaces 172 of the spacer 17.

As shown in FIG. 4C, the buffer member 18 covers the entire fifth top surface 171 of the spacer 17 as well as the opposite two side surfaces 172 of the spacer 17. This disclosure is not limited. In some embodiments, the buffer member 18 can cover one of the side surfaces 172 of the spacer 17 or a part of one of the side surfaces 172 of the spacer 17.

As shown in FIG. 4D, the buffer member 18 covers a part of the fifth top surface 171 of the spacer 17. One of the side surfaces 172 of the spacer 17 is substantially aligned to the buffer member 18, and another one of the side surfaces 172 of the spacer 17 is not substantially aligned to the buffer member 18 while a part of the fifth top surface 171 is exposed.

As shown in FIG. 4E, the buffer member 18 covers one of the side surfaces 172 and a part of the fifth top surface 171 of the spacer 17, but the buffer member 18 does not cover the other one of the side surfaces 172 of the spacer 17.

As shown in FIG. 4F, the buffer member 18 covers the entire fifth top surface 171 and one of the two opposite side surfaces 172 of the spacer 17, and is substantially aligned to the other one of the two opposite side surfaces 172 of the spacer 17. The above-mentioned aspects of the buffer member 18 and the spacer 17 are for illustrations and are not to limit the disclosure.

In practice, when the automatic dispensing machine outputs the adhesive to form the buffer member 18, the four turning corners of the supporting frame 16 are applied with more amount of adhesive due to the turning path of the automatic dispensing machine. Thus, the four turning corners of the supporting frame 16 will be applied with thicker adhesive layer, so that the formed buffer member 18 has thicker and wider parts at the four corners. In other words, the corner areas of the buffer member 18 are higher than the non-corner areas of the buffer member 18. This structure can reduce the supporting and buffering functions for the display panel 11.

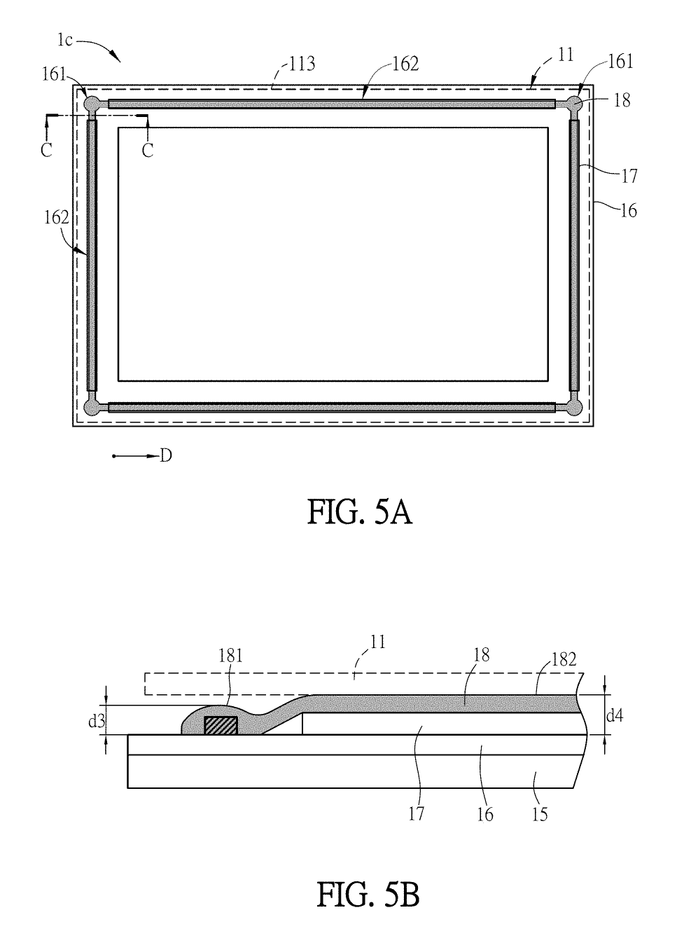

The present disclosure further provides a display device 1b to overcome the undesired structure of the above manufacturing process. FIG. 5A is a top view of the display device 1b according to another embodiment of the disclosure, and FIG. 5B is a sectional view of the display device 1b of FIG. 5A along a line C-C.

Different from the display device 1b, as shown in FIG. 5A, the supporting frame 16 further includes a turning region 161 and a main body region 162, and the display panel 11 further includes a side edge 113 extending along a direction D. The main body region 162 corresponds to the side edge 113, extends along the direction D and connects to the turning region 161. In this embodiment, the spacer 17 is disposed on the main body region 162 and is not disposed on the turning region 161. In more detailed, the supporting frame 16 of this embodiment is a square, which has four turning regions 161 (at four corners) and four main body regions 162. The turning regions 161 are the turned portions of the supporting frame 16, and the main body regions 162 are the straight extended portions of the supporting frame 16. The four main body regions 162 are extending along and corresponding to the four side edges 113 of the display panel 11. Each turning region 161 is connected to two main body regions 162, and each main body region 162 is connected to two turning regions 161. In this embodiment, the spacer 17 is disposed on the main body region 162 and is not disposed on the turning region 161.

As shown in FIG. 5B, since the turning regions 161 of the supporting frame 16 are not configured with the spacer 17, the buffer member 18 can directly contact with the supporting frame 16 in the turning regions 162. Besides, the main body regions 162 are configured with the spacer 17. Accordingly, in the turning regions 161, the buffer member 18 is disposed on the supporting frame 16 and located between the supporting frame 16 and the display panel 11 (the buffer member 18 is not contacted with the display panel 11). In the main body regions 162, the buffer member 18 is disposed on the spacer 17 and located between the spacer 17 and the display panel 11, so that the buffer member 18 can contact with the display panel 11 in the main body regions 162 for providing the supporting and buffering functions.

In addition, the buffer member 18 has a third top surface 181 (the highest portion) away from the supporting frame 16 at the turning region 161 and a fourth top surface 182 away from the supporting frame 16 at the main body region 162. The third top surface 181 does not contact with the display panel 11, and the fourth top surface 182 contacts with the display panel 11. A shortest distance d3 between the third top surface 181 and the supporting frame 16 is less than a shortest distance d4 between the fourth top surface 182 and the supporting frame 16 (d3<d4). In other words, the sum of the heights of the buffer member 18 and the spacer 17 at the main body region 162 is greater than the height of the buffer member 18 at the turning region 161.

In this embodiment, the main body region 162 of the supporting frame 16 is configured with the spacer 17, but the turning region 161 of the supporting frame 16 is not configured with the spacer 17. Accordingly, this disclosure can overcome the issue of excess and thicker adhesive amount in the turning region 161 when the automatic dispensing machine outputs the adhesive to form the buffer member 18. Moreover, the buffer member 18 formed on the main body region 162 can provide sufficient buffering and supporting functions for the display panel 11.

To sum up, in the display device of this disclosure, the circuit connecting board is connected to the display pane, and the passive components are disposed on the component configuration area of the circuit connecting board. The first insulation layer is disposed on the component configuration area and covers the first passive component. Accordingly, the adhesive can be applied on the component configuration area of the circuit connecting board by an automatic dispensing machine, and the adhesive is solidified to form the first insulation layer for covering the passive component. This configuration can reduce the short circuit between the metal material and the components disposed on the component configuration area of the circuit connecting board, thereby benefitting in automatically manufacturing and decreasing the production cost.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel;
a circuit connecting board connected to the display panel and having a component configuration area;
a plurality of passive components disposed on the component configuration area and comprising a first passive component; and
a first insulation layer disposed on the component configuration area and covering the first passive component.

2. The display device of claim 1, wherein the display panel comprises a first substrate and a second substrate disposed corresponding to and overlapping with each other, and the circuit connecting board is connected to a surface of the first substrate facing the second substrate.

3. The display device of claim 1, wherein the first insulation layer has a first surface away from the circuit connecting board, the first passive component has a top surface closest to the first surface, and a shortest distance between the top surface and the first surface is greater than or equal to 30 μm and is less than or equal to 50 μm.

4. The display device of claim 1, wherein the first insulation layer has a first surface away from the circuit connecting board, the passive components further comprise a second passive component, the first insulation layer further covers the second passive component, the first passive component has a first top surface closest to the first surface, a first distance is between the first top surface and the first surface, the first distance is a shortest distance between the first passive component and the first surface, the second passive component has a second top surface closest to the first surface, a second distance is between the second top surface and the first surface, the second distance is a shortest distance between the second passive component and the first surface, and the first distance is different from the second distance.

5. The display device of claim 1, further comprising:
a second insulation layer, wherein the circuit connecting board further has a bonding area, the bonding area is configured with a connecting pad, and the second insulation layer is disposed on the bonding area and covers the connecting pad.

6. The display device of claim 5, wherein the first insulation layer and the second insulation layer comprise the same material.

7. The display device of claim 5, wherein the first insulation layer or the second insulation layer comprises an adhesive material.

8. The display device of claim 1, further comprising:
a backlight module;
a supporting frame disposed on the backlight module and located between the backlight module and the display panel;
a spacer disposed on the supporting frame; and
a buffer member disposed between the spacer and the display panel or between the supporting frame and the display panel.

9. The display device of claim 8, wherein the supporting frame has a square shape disposed surrounding a periphery of the display panel.

10. The display device of claim 8, wherein the supporting frame is a single-piece component.

11. The display device of claim 8, wherein the supporting frame has a turning region, and the buffer member contacts the supporting frame at the turning region.

12. The display device of claim 11, wherein the supporting frame further has a main body region, the display panel further has a side edge extending along a direction, and the main body region corresponds to the side edge, extends along the direction and connects to the turning region.

13. The display device of claim 12, wherein the buffer member has a third top surface away from the supporting frame at the turning region and a fourth top surface away from the supporting frame at the main body region, and a shortest distance between the third top surface and the supporting frame is less than a shortest distance between the fourth top surface and the supporting frame.

14. The display device of claim 11, wherein the supporting frame further has at least two main body regions and the turning region is connected to two of the at least two main body regions.

15. The display device of claim 11, wherein the buffer member is disposed on the supporting frame and located between the supporting frame and the display panel.

16. The display device of claim 8, wherein the spacer has a fifth top surface, and the buffer member covers at least a part of the fifth top surface.

17. The display device of claim 8, wherein the spacer has a side surface, and the buffer member covers at least a part of the side surface.

18. The display device of claim 17, wherein the buffer member is substantially aligned to the side surface of the spacer.

19. The display device of claim 8, wherein the spacer has a side surface and a fifth top surface, and the buffer member covers at least a part of the side surface and at least a part of the fifth top surface.

20. The display device of claim 1, further comprising:
a system circuit board electrically connected to the display panel through the circuit connecting board.
